(19) United States
(12) Patent Application Publication
(10) Pub. No.: US 2015/0179360 A1
(43) Pub. Date: Jun. 25, 2015

(54) INSTANT TRIP DEVICE OF CIRCUIT BREAKER

(71) Applicant: LSIS CO., LTD., Anyang-si (KR)

(72) Inventor: Kwang Won LEE, Cheongju-si (KR)

(73) Assignee: LSIS CO., LTD., Anyang-si (KR)

(21) Appl. No.: 14/532,878

(22) Filed: Nov. 4, 2014

(30) Foreign Application Priority Data
Dec. 19, 2013 (KR) 10-2013-0159510

(51) Int. Cl. H01H 3/38; H01H 3/28

(52) U.S. Cl. CPC H01H 3/38; H01H 3/28

(57) ABSTRACT

An instant trip device of a circuit breaker comprises a magnet; a supporter; an amateur provided between the magnet and the supporter and including a rotation center portion and a rotating part is disposed to be rotatable with respect to the rotation center portion; and an amateur spring configured to apply an elastic force in a direction where the rotating part of the amateur becomes farther away from the magnet, wherein a groove of which one side is opened is formed at the supporter to support the rotation center portion, wherein a boss is formed at the rotation center portion to be inserted into the groove, and wherein the amateur spring is an extension spring in which one end of the amateur spring is supported by a first hanger included in the supporter, and the other end is supported by a second hanger included in the rotating part.

### CROSS-REFERENCE TO RELATED APPLICATION

Pursuant to 35 U.S.C. §119(a), this application claims the benefit of earlier filing date and right of priority to Korean Application No. 10-2013-0159510, filed on Dec. 19, 2013, the contents of which are all hereby incorporated by reference herein in its entirety.

### BACKGROUND OF THE DISCLOSURE

1. Field of the Disclosure

The present disclosure relates to an instant trip device of a circuit breaker, and particularly, to an instant trip device of a circuit breaker, which can secure a reliability of an instant operation and reduce the cost.

2. Background of the Disclosure

Generally, breaker circuits are a type of electronic device that manually switches on or off an electric circuit by using a handle, or when a fault current such as a short circuit current occurs, detects the fault current to automatically break the electric circuit, thereby protecting a load device and the electric circuit.

FIG. 1 is a cross-sectional view illustrating a relate art circuit breaker. FIG. 2 is a main cross-sectional view illustrating an instant trip device and a crossbar of FIG. 1. FIG. 3 is a perspective view illustrating an assembly process of the instant trip device of FIG. 3. FIG. 4 is a perspective view illustrating an assembly completion state of FIG. 3.

As illustrated in FIGS. 1 to 4, the related art circuit breaker includes a case 10, a fixed contact 20 that is fixedly disposed at the case 10, a moving contact 30 that is disposed to be contactable with and detachable from the fixed contact 20, a switching mechanism 40 that switches on or off the moving contact 30, and an instant trip device 60 that, when a fault current such as a short circuit current occurs, detects the fault current and automatically triggers the switching mechanism 40 in order for the switching mechanism 40 to move to a tripping position within a momentary time. A handle 50 is further provided in an upper region of the case 10 so as to manually switch on or off the switching mechanism 40.

The instant trip device 60 includes a magnet 62 that generates a magnetic absorbing force in exciting, an amateur 66 that is disposed at one side of the magnet 62 and is absorbed by the magnet 62, a supporter 64 that rotatably supports the amateur 66 at an opposite side of the magnet 62 with respect to the amateur 66, and an amateur spring 68 that applies an elastic force in a direction where the amateur 66 becomes farther away from the magnet 62.

The amateur 66 includes a first moving plate 66a and a second moving plate 66b that is bent to be approximately vertical to the first moving plate 66a. The second moving plate 66b includes a shaft hole 66d into which a shaft 69 is inserted.

The supporter 64 includes a first fixed plate 64a and a second fixed plate 64b that is bent to be approximately vertical to the first fixed plate 64a. The second fixed plate 64b includes a shaft supporting part 64c that rotatably supports the amateur 66. A shaft inserting hole 64d, into which the shaft 69 is inserted, is formed at the shaft supporting part 64c.

The amateur spring 68 is a double torsion spring, and a coil 68d passes through the amateur spring 68 by the shaft 69. One end of the amateur spring 68 is supported by the supporter 64, and the other end is supported by the amateur 66.

A crossbar 71, a trip shooter 73, a trip bar 75, and a latch holder 77 are provided at one side of the amateur 66. When the amateur 66 is rotated by the magnet 62, the crossbar 71, the trip shooter 73, the trip bar 75, and the latch holder 77 perform a function (a trigger function) of binding a latch (not shown) of the switching mechanism 40 and releasing the binding of the latch.

Due to such a configuration, when a fault current flows through the magnet 62, the magnet 62 is magnetized to generate a magnetic absorbing force. When the magnetic absorbing force is greater than a weight of the amateur spring 68, the amateur 66 is absorbed to the magnet 62 side, and is rotated. When the amateur 66 is rotated to rotate the crossbar 71, the trip shooter 73, the trip bar 75, and the latch holder 77 are continuously rotated to bind the latch (not shown) of the switching mechanism 40 and release the binding of the latch. When the binding of the latch (not shown) is released, the moving contact 30 is quickly detached from the fixed contact 20 by an elastic force of a trip spring (not shown) of the switching mechanism 40.

However, in the instant trip device 60 of the related art circuit breaker, the shaft inserting hole 64d of the supporter 64, the shaft hole 66d of the amateur 66, and the coil 68d of the amateur spring 68 are disposed in one row on the same axis, and the shaft 69 is inserted to pass through the elements, whereby the instant trip device is assembled. For this reason, an assembly process is complicated, causing a reduction in assemblability.

Moreover, in the related art instant trip device 60, a problem of scattering, a problem of distortion, and a problem of obstructing a movement of the amateur are caused by an accumulation tolerance between the shaft inserting hole 64d of the supporter 64, the shaft hole 66d of the amateur 66, the coil 68d of the amateur spring 68, and the shaft 69. For this reason, a reliability of an instant operation is reduced.

Moreover, in the related art instant trip device 60, the shaft 69 deviates from a normal position when an element is moved and kept.

Moreover, in the related art instant trip device 60, the number of elements increases due to the separate use of the shaft 69, and the cost increases due to the use of an expensive double torsion spring.

### SUMMARY OF THE DISCLOSURE

Therefore, an aspect of the detailed description is to provide an instant trip device of a circuit breaker in which a structure is simplified, and thus, assemblability can be enhanced.

Another aspect of the detailed description is to provide an instant trip device of a circuit breaker, which solves a problem of scattering, a problem of distortion, and a problem of obstructing a movement of an amateur, thereby enhancing a reliability of an instant operation.

Another aspect of the detailed description is to provide an instant trip device of a circuit breaker, which solves a problem in which a shaft deviates from a normal position.

Another aspect of the detailed description is to provide an instant trip device of a circuit breaker in which the number of elements and the cost are reduced.

To achieve these and other advantages and in accordance with the purpose of this specification, as embodied and broadly described herein, an instant trip device of a circuit breaker includes: a magnet configured to generate a magnetic absorbing force with power applied thereto; a supporter disposed at a side opposite to the magnet; an amateur provided between the magnet and the supporter, and including a rotation center portion and a rotating part is disposed to be rotatable with respect to the rotation center portion; and an amateur spring configured to apply an elastic force in a direction where the rotating part of the amateur becomes farther away from the magnet, wherein a groove of which one side is opened is formed at the supporter to support the rotation center portion of the amateur, wherein a boss is formed at the rotation center portion of the amateur to be inserted into the groove, and wherein the amateur spring is an extension spring in which one end of the amateur spring is supported by a first hanger included in the supporter, and the other end is supported by a second hanger included in the rotating part of the amateur.

The opened one side of the groove may be formed in a direction of the rotating part.

The first hanger may be provided at a position which is more adjacent to the groove than the second hanger, and an elastic force may be applied in a direction where a contact state between the groove and the boss is maintained.

The supporter may include a spring accommodating part which is formed at a side of the first hanger to pass through the supporter, so that there is no interference between the supporter and the amateur spring.

A portion of the groove which is pressured by the boss may be formed in a semicircular shape, the boss may be formed in a cylindrical shape, and a curvature radius of the semicircular portion of the groove may be equal to or greater than a radius of the boss.

A pair of the bosses may be provided on a rotating axis of the amateur to be symmetric with respect to the amateur, and a pair of the grooves may be provided in correspondence with the pair of bosses.

Further scope of applicability of the present application will become more apparent from the detailed description given hereinafter. However, it should be understood that the detailed description and specific examples, while indicating preferred embodiments of the disclosure, are given by way of illustration only, since various changes and modifications within the spirit and scope of the disclosure will become apparent to those skilled in the art from the detailed description.

### BRIEF DESCRIPTION OF THE DRAWINGS

The accompanying drawings, which are included to provide a further understanding of the disclosure and are incorporated in and constitute a part of this specification, illustrate exemplary embodiments and together with the description serve to explain the principles of the disclosure.

In the drawings:

FIG. 1 is a cross-sectional view illustrating a relate art circuit breaker;

FIG. 2 is a main cross-sectional view illustrating an instant trip device and a crossbar of FIG. 1;

FIG. 3 is a perspective view illustrating an assembly process of the instant trip device of FIG. 3;

FIG. 4 is a perspective view illustrating an assembly completion state of FIG. 3;

FIG. 5 is a main cross-sectional view illustrating an instant trip device and a crossbar according to an embodiment of the present invention;

FIG. 6 is a main cross-sectional view illustrating an amateur assembly of the instant trip device of FIG. 5;

FIG. 7 is a perspective view illustrating an assembly process of the amateur assembly of FIG. 6;

FIG. 8 is a perspective view illustrating an assembly completion state of FIG. 6; and

FIG. 9 is a perspective view when FIG. 8 is seen from the amateur.

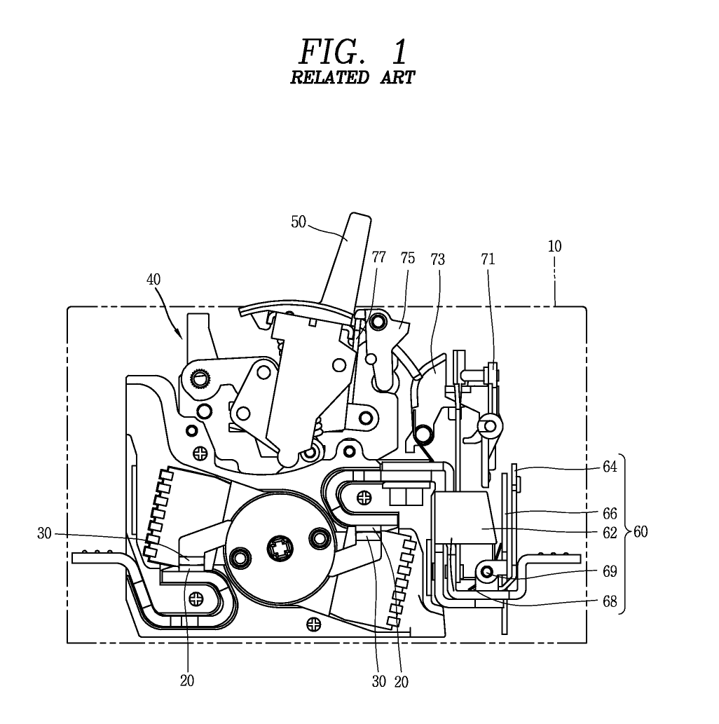

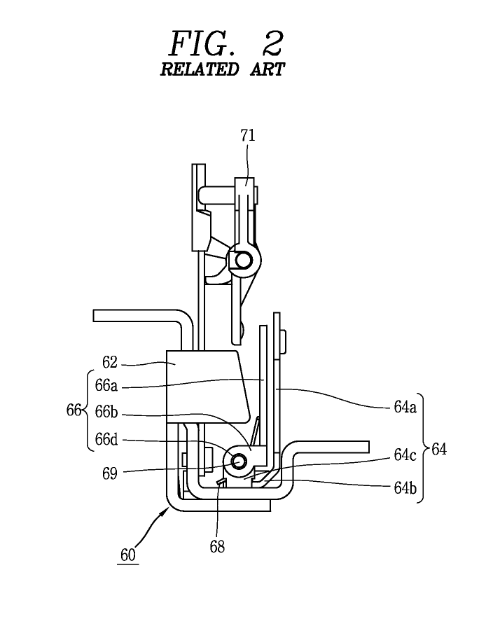

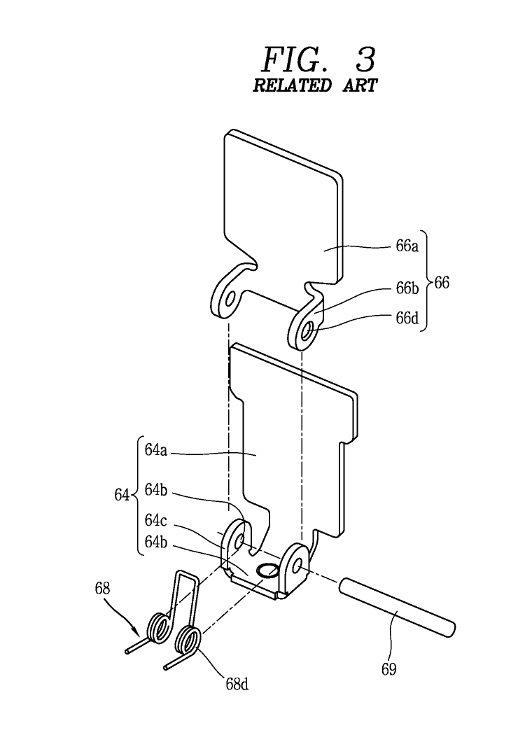

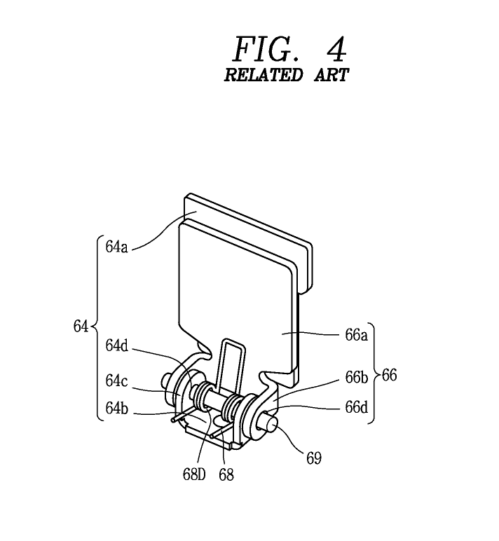

### DETAILED DESCRIPTION OF THE DISCLOSURE

Description will now be given in detail of the exemplary embodiments, with reference to the accompanying drawings. For the sake of brief description with reference to the drawings, the same or equivalent components will be provided with the same reference numbers, and description thereof will not be repeated.

Hereinafter, embodiments of the present invention will be described in detail with reference to the accompanying drawings.

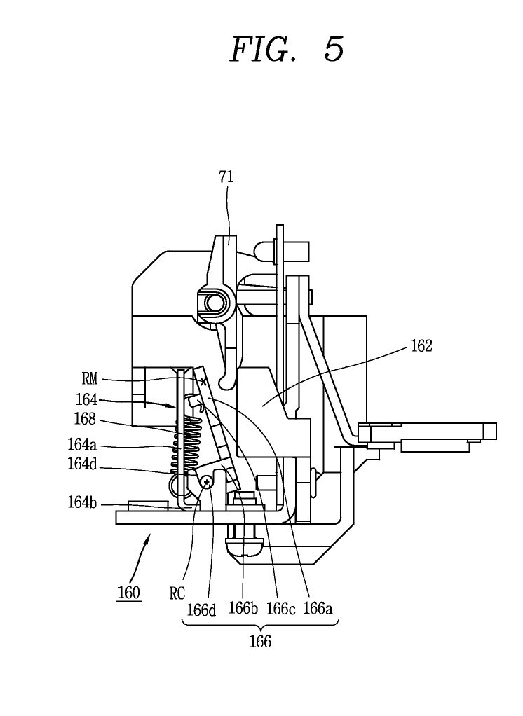

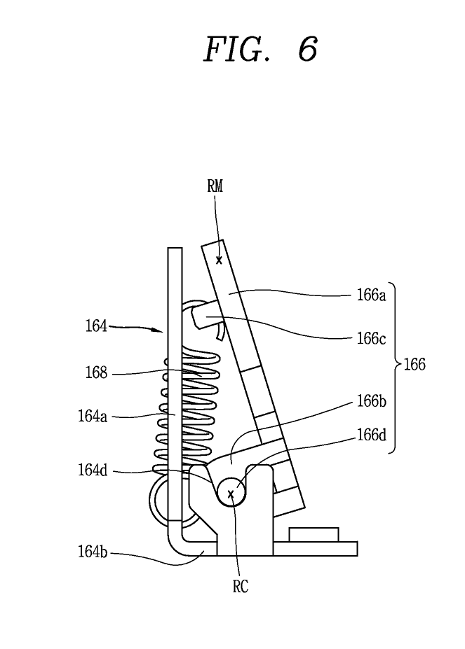

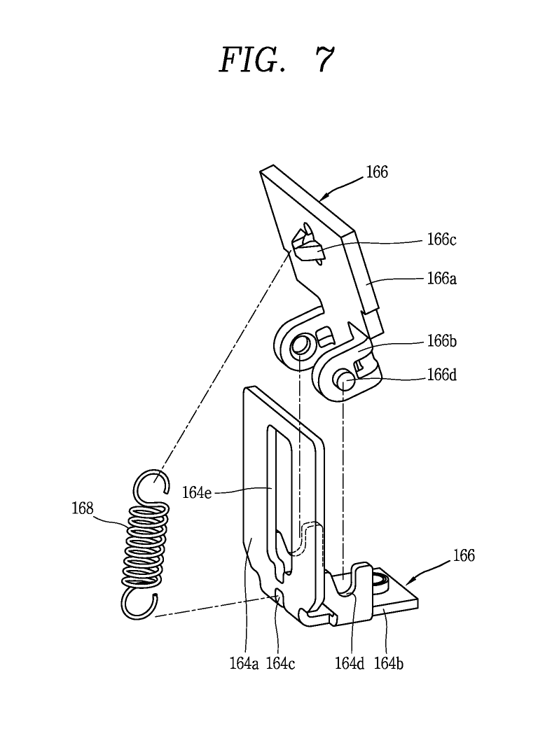

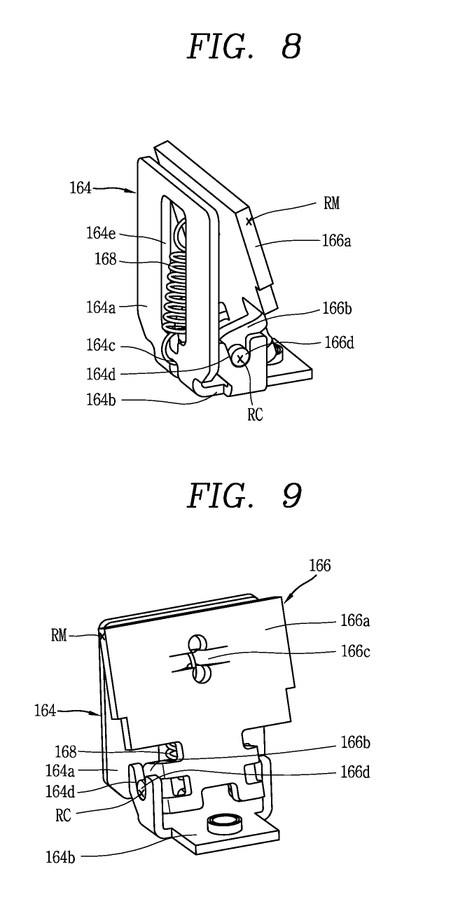

FIG. 5 is a main cross-sectional view illustrating an instant trip device and a crossbar according to an embodiment of the present invention. FIG. 6 is a main cross-sectional view illustrating an amateur assembly of the instant trip device of FIG. 5. FIG. 7 is a perspective view illustrating an assembly process of the amateur assembly of FIG. 6. FIG. 8 is a perspective view illustrating an assembly completion state of FIG. 6. FIG. 9 is a perspective view when FIG. 8 is seen from the amateur.

As seen in FIGS. 5 to 9, an instant trip device 160 according to an embodiment of the present invention may include a magnet 162 that generates a magnetic absorbing force with power applied thereto, a supporter 164 that is disposed at a side opposite to the magnet 162, an amateur 166 in which a rotating part RM is disposed to be rotatable in a first direction and a second direction with respect to a rotation center portion RC and between the magnet 162 and the supporter 164, and an amateur spring 168 that applies an elastic force in a direction where the rotating part RM of the amateur 166 becomes farther away from the magnet 162.

For reference, a mechanism configured with the supporter 164, the amateur 166, and the amateur spring 168 is referred to as an amateur assembly.

The magnet 162 may be connected to a fixed contact (not shown) so as to enable electricity to be conducted.

The supporter 164 may include a first fixed plate 164a and a second fixed plate 164b which is bent to be approximately vertical to the first fixed plate 164a.

The first fixed plate 164a may include a first hanger 164c and a spring accommodating part 164e.

The first hanger 164c may be formed of a groove so that one end of the amateur spring 186 is hanged on a lower side of the first fixed plate 164a. In other words, the first hanger 164c may be formed of a groove so that the one end of the amateur spring 168 is hanged on a position adjacent to a below-described boss accommodating groove 164d of the first fixed plate 164a.

The spring accommodating part 164e may be formed of a groove, which passes through the first fixed plate 164a, at a side of the first hanger 164c so that there is no interference between the first fixed plate 164a and the amateur spring 168 when the amateur assembly is assembled.

The second fixed plate 164b may include a pair of grooves 164d (hereinafter referred to as a boss accommodating groove) of which one side is opened.

A below-described boss 166d of the amateur 166 may be inserted into the boss accommodating groove 164d, and thus, the rotation center portion RC of the amateur 166 may be provided in the boss accommodating groove 164d. In this case, the boss accommodating groove 164d may be formed in a U-shape where one side of the boss accommodating groove 164d is opened in a direction from the rotation center portion CM to the rotating part RM, and a portion which is pressured by the boss 166d has a semicircular shape.

The first hanger 164c may be provided under the first fixed plate 164a with respect to a below-described second hanger 166c. In other words, the first hanger 164c may be more adjacent to the boss accommodating groove 164d than the below-described second hanger 166c, and may be provided at a position opposite to the magnet 162 with respect to the boss accommodating groove 164d.

The amateur 166 may include a first moving plate 166a that is the rotating part RM and a second moving plate 166b that is bent to be approximately vertical to the first moving plate 166a.

The second hanger 166c, which is formed in a groove form, may be provided at one side of the first moving plate 166a so that the other end of the amateur spring 168 is hanged on the second hanger 166c.

The second moving plate 166b may include a pair of bosses 166d which are inserted in the boss accommodating groove 164d of the supporter 164, and are formed in a cylindrical shape so as to configure the rotation center portion RC.

In this case, in order for the amateur 166 to smoothly rotate, the boss 166d may be formed in a cylindrical shape, the boss accommodating groove 164d may be formed in a U-shape where the portion which is pressured by the boss 166d has a semicircular shape, and a curvature radius of a semicircular portion of the boss accommodating groove 164d may be equal to or greater than a radius of a circular cross-sectional surface of the boss 166d. However, when it is possible for amateur 166 to rotate, the boss 166d and the boss accommodating groove 164d may be formed in different shapes.

Moreover, the pair of bosses 166d may be provided on a rotating axis of the amateur 166 to be symmetric with respect to the amateur 166, and in correspondence with the pair of bosses 166d, the pair of boss accommodating grooves 164d may be provided on the rotating axis of the amateur 166 to be symmetric with respect to the supporter 164.

The amateur spring 168 is an extension spring. One end of the amateur spring 168 may be supported by the first hanger 164c, and the other end may be supported by the second hanger 166c.

In the drawings, like reference numerals refer to like elements.

Hereinafter, an operation and effects of the instant trip device 160 of the circuit breaker according to an embodiment of the present invention will be described in detail.

The instant trip device 160 of the circuit breaker according to an embodiment of the present invention may be sequentially assembled through the following process. That is, the boss 166d which is formed as one body with the amateur 166 may be inserted into and accommodated in the boss accommodating groove 164d, and thus, the amateur 166 may be rotatably coupled to the supporter 164. One end of the amateur spring 168 may be hanged on the first hanger 164c, and the other end may be hanged on the second hanger 166c. Therefore, a coupled state of the amateur 166 and the supporter 164 is maintained, and the magnet 162 which is separately provided may be coupled thereto.

In the instant trip device 160 which is assembled in this way, a contact state between the boss accommodating groove 164d of the supporter 164 and the boss 166d of the amateur 166 may be normally maintained by an elastic force of the amateur spring 168. In other words, in the instant trip device 160, a rotatable coupling state between the supporter 164 and the amateur 166 may be normally maintained by the elastic force of the amateur spring 168. Also, in the instant trip device 160, due to the elastic force of the amateur spring 168, the rotating part RM of the amateur 166 may become farther away from the magnet 162, but a state of being supported by the first fixed plate 164a of the supporter 164 may be maintained.

When a fault current such as a short circuit current occurs in a circuit, the magnet 162 may be magnetized to generate a magnetic absorbing force. When the magnetic absorbing force is greater than a weight of the amateur spring 168, the first moving plate 166a of the amateur 166 may be absorbed to the magnet 162 side, and may be rotated. In other words, when the magnetic absorbing force is greater than the weight of the amateur spring 168, the rotating part RM of the amateur 166 may clockwise rotate in FIG. 5. When the amateur clockwise rotates in FIG. 5, the latch (not shown) of the switching mechanism (not shown) may be bound, and the binding of the latch may be released. When the binding of the latch is released, a moving contact (not shown) may be quickly detached from a fixed contact (not shown).

Here, in the instant trip device 160 of the circuit breaker according to an embodiment of the present invention, the rotation center portion RC of the amateur 166 may be implemented by the boss accommodating groove 164d with one side opened of the supporter 164 and the boss 166d which is formed as one body with the amateur 166. Also, in the instant trip device 160 of the circuit breaker according to an embodiment of the present invention, an elastic force may be applied in a direction where the amateur 166 deviates from the magnet 162 due to the amateur spring 168, and a rotatable coupling state between the supporter 164 and the amateur 166 may be maintained by the amateur spring 168.

Due to such a configuration, in the instant trip device 160 of the circuit breaker according to the embodiments of the present invention, a structure is simplified, and thus, assemblability can be enhanced. Also, the instant trip device 160 of the circuit breaker according to the embodiments of the present invention solves a problem of scattering, a problem of distortion, and a problem of obstructing a movement of an amateur, which are caused by the accumulation tolerance of the rotation center portion, thereby enhancing a reliability of an instant operation. Also, when an element is moved and kept, the instant trip device 160 of the circuit breaker according to the embodiments of the present invention can solve a problem in which the shaft deviates from a normal position and which is caused by the separate use of the shaft. Also, the number of elements and the cost are reduced compared to the related art.

In addition to the instant trip device 160 according to an embodiment of the present invention, other elements, operations, and effects of the circuit breaker are the same as those of the related art, and thus, their detailed descriptions are not provided.

The foregoing embodiments and advantages are merely exemplary and are not to be considered as limiting the present disclosure. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present features may be embodied in several forms without departing from the characteristics thereof, it should also be understood that the above-described embodiments are not limited by any of the details of the foregoing description, unless otherwise specified, but rather should be considered broadly within its scope as defined in the appended claims, and therefore all changes and modifications that fall within the metes and bounds of the claims, or equivalents of such metes and bounds are therefore intended to be embraced by the appended claims.

What is claimed is:

1. An instant trip device of a circuit breaker, the instant trip device comprises:
a magnet configured to generate a magnetic absorbing force with power applied thereto;
a supporter disposed at a side opposite to the magnet;
an amateur is provided between the magnet and the supporter, and including a rotation center portion and a rotating part is disposed to be rotatable with respect to the rotation center portion; and
an amateur spring configured to apply an elastic force in a direction where the rotating part of the amateur becomes farther away from the magnet,
wherein,
a groove of which one side is opened is formed at the supporter to support the rotation center portion of the amateur,
a boss is formed at the rotation center portion of the amateur to be inserted into the groove, and
the amateur spring is an extension spring in which one end of the amateur spring is supported by a first hanger included in the supporter, and the other end is supported by a second hanger included in the rotating part of the amateur.

2. The instant trip device of claim 1, wherein the opened one side of the groove is formed in a direction of the rotating part.

3. The instant trip device of claim 2, wherein the first hanger is provided at a position which is more adjacent to the groove than the second hanger, and an elastic force is applied in a direction where a contact state between the groove and the boss is maintained.

4. The instant trip device of claim 1, wherein the supporter comprises a spring accommodating part which is formed at a side of the first hanger to pass through the supporter, so that there is no interference between the supporter and the amateur spring.

5. The instant trip device of claim 1, wherein,
a portion of the groove which is pressured by the boss is formed in a semicircular shape,
the boss is formed in a cylindrical shape, and
a curvature radius of the semicircular portion of the groove is equal to or greater than a radius of the boss.

6. The instant trip device of claim 1, wherein,
a pair of the bosses are provided on a rotating axis of the amateur to be symmetric with respect to the amateur, and
a pair of the grooves are provided in correspondence with the pair of bosses.
